(19) United States
(12) Patent Application Publication
(10) Pub. No.: US 2010/0323323 A1
(43) Pub. Date: Dec. 23, 2010

(54) Pliable gingival isolation material

(75) Inventor: Robert K. Larsen, Sandy, UT (US)

Correspondence Address: CAO Group, Inc., 4628 W. Skyhawk Drive, West Jordan, UT, 84084, US

(73) Assignee: Cao Group, Inc., West Jordan, UT (US)

(21) Appl. No.: 11/473,384

(22) Filed: Jun. 22, 2006

Related U.S. Application Data
(60) Provisional application No. 60/693,971, filed on Jun. 24, 2005.

(51) Int. Cl. A61C 5/14

(52) U.S. Cl. 433/136

(57) ABSTRACT

A gingival isolation material that is pliable once cured or set. The isolation material can include components such as water, a thickening agent, a plasticizer, a dye and a preservative.

### CLAIM FOR PRIORITY

This patent application claims priority to and benefit of U.S. Provisional Patent Application Ser. No. 60/693,971 filed on Jun. 24, 2005.

### BACKGROUND

Gingival isolation is a procedure performed in dentistry, and there is some advantage found in using a pliable gingival isolation material. Materials commonly employed in the practice of dentistry contain components that while generally safe for contact with the tooth structure, these components can be anywhere from irritating to corrosive to soft oral tissues. Methods and materials are currently used to isolate or protect oral tissue adjacent to exposed tooth structure when such dental materials are in use. These isolation systems are generally designed to prevent the irritating materials from penetrating through the isolation material to reach the tissue. Generally, these isolation materials are flexible in nature when first applied. Some of these materials can be treated or cured to form a rigid barrier designed to prevent the accidental displacement of the isolation material during the dental procedure. In spite of these measures, whether the material remains flexible or takes a rigid form, these isolation materials often become displaced anyway, allowing the harsh materials to penetrate past the isolation and come in contact with soft tissue. A material is needed that adheres or remains in intimate contact with soft tissue that remains flexible, that resists penetration by dental materials, and that resists dissolution by the dental materials, until the removal of the isolation material is desired.

### DETAILED DESCRIPTION

The isolation material includes water, thickening agents, a plasticizer, a filler, and a dye or pigment. The material may also contain a pain management substance.

Thickening agents that may be used include any of a variety of molecular weights of polyethylene glycol (polyethylene oxide), polypropylene glycol, polyvinyl pyrrolidone, polyacrylic acid (Carbopol), polyvinyl alcohol, cellulosic compounds such as hydroxyethyl cellulose and carboxymethyl cellulose, natural gums such as gum karaya, xanthan gum, Guar gum, gum arabic, and gum tragacanth, Pemulen® made by B. F. Goodrich Company, and any block copolymers of the above mentioned.

Plasticizers may include glycerin, prolpylene glycol, low molecular weight polyethylene glycol, mineral oil, triethyl citrate, acetyltriethyl citrate, lauric acid, modified vegetable oils, diacetylated monoglycerides, castor oil, triacetin, liquid poly propylene glycols, dimethyl phthalate, diethyl phthalate, dipropyl phthlate, dibutyl phthalate, dioctyl phthalate, or polysorbates.

Fillers may include small particulate or fumed silicon dioxide, titanium oxide, water insoluble particles of polycaprolactones, polyimide-imide, phenolic, nylon, fluoropolymers, acrylics, acrylonitrile-butadiene-styrene, cellulosics, polybutylene, polycarbonate, polyethylene, polyimides, polyphenylene oxide, polypropylene, polystyrene, polyurethanes, polyvinyl acetates, polyvinyl chloride, poly(vinyl alcohol-co ethylene), styrene acrylonitrile, and saturated or unsaturated polyesters.

Dyes and pigments may include any of the U.S. FDA approved FD&C dyes such as Blue #1 or Yellow #5. Substances for providing pain management may include benzocaine or lidocaine.

The resulting composition features a viscosity sufficient to prevent the material from flowing away from the tissue to which it is applied to adjacent surfaces. The composition is of sufficient viscosity to prevent other dental materials from penetrating or ingressing into the gel to the extent that these other materials are capable of penetrating through the isolation material and coming into contact with the protected tissue. The composition features a surface adhesion sufficient to allow the composition to remain in intimate contact with the oral tissue, even when external force is exerted on portions of the gel distal to the isolation/tissue interface. The composition remains flexible or pliable during the course of the dental procedure. The composition resists dissolution by water or other solvents that come in incidental contact with the composition, but the application of a solvent such as water, combined with an applied mechanical action, is capable of removing the composition from the oral tissue with minimal irritation to the oral tissue. The isolation material is applied in a manner similar to other currently available tissue isolation systems.

### Example Formula #1

10-20%—water

20-30%—thickening agent

30-50%—plasticizer

0.001-0.01%—dye

### Example Formula #2

0-10%—water

35-50%—thickening agent

40-60%—plasticizer

0.05-0.2%—preservative

0.001-0.01%—dye

### Example Formula #3

15-30%—water

20-45%—thickening agent

15-30%—plasticizer

0.001-0.01%—dye

While the present invention has been described and illustrated in conjunction with a number of specific embodiments, those skilled in the art will appreciate that variations and modifications may be made without departing from the principles of the invention as herein illustrated, described, and claimed. The present invention may be embodied in other specific forms without departing from its spirit or essential characteristics. The described embodiments are to be considered in all respects as only illustrative, and not restrictive. All changes which come within the meaning and range of equivalency of the claims are to be embraced within their scope.

I claim:

1. A pliable gingival isolation material comprising:
water,
at least one thickening agent,
at least one a plasticizer,
at least one filler, and
at least one dye or pigment.

2. A material as recited in claim 1 further comprising a pain management substance.

3. A material as recited in claim 1 wherein said thickening agents is selected from the group consisting of polyethylene glycol, polyethylene oxide, polypropylene glycol, polyvinyl pyrrolidone, polyacrylic acid, polyvinyl alcohol, cellulosic compounds such as hydroxyethyl cellulose and carboxymethyl cellulose, gum and block copolymers.

4. A material as recited in claim 1 wherein said plasticizer is selected from the group consisting of glycerin, prolpylene glycol, low molecular weight polyethylene glycol, mineral oil, triethyl citrate, acetyltriethyl citrate, lauric acid, modified vegetable oils, diacetylated monoglycerides, castor oil, triacetin, liquid poly propylene glycols, dimethyl phthalate, diethyl phthalate, dipropyl phthlate, dibutyl phthalate, dioctyl phthalate, and polysorbates.

5. A material as recited in claim 1 wherein said filler is selected from the group consisting of silicon dioxide, titanium oxide, polycaprolactones, polyamide-imide, phenolic, nylon, fluoropolymers, acrylics, acrylonitrile-butadiene-styrene, cellulosics, polybutylene, polycarbonate, polyethylene, polyimides, polyphenylene oxide, polypropylene, polystyrene, polyurethanes, polyvinyl acetates, polyvinyl chloride, poly(vinyl alcohol-co ethylene), styrene acrylonitrile, and polyesters.

6. A material as recited in claim 2 wherein said pain management substance is selected from the group consisting of benzocaine and lidocaine.

7. A material as recited in claim 1 wherein the material has a viscosity sufficient to prevent it from flowing away from human gum tissue under the force of gravity.

8. A material as recited in claim 1 wherein the material is capable of preventing other florable dental substances the tissue to which it is applied to adjacent surfaces. The composition is of sufficient from penetrating the pliable gingival isolation material in order to reach gingival tissue.

9. A material as recited in claim 1 wherein the material has a surface adhesion sufficient to allow the gingival isolation material to remain in intimate contact with gingival tissue even when external force is exerted on portions of the gingival isolation material.

10. A material as recited in claim 1 wherein the material resists dissolution by water.

11. A pliable gingival isolation material comprising:
about 10 to 20% water,
about 20 to 30% thickening agent, and
about 30 to 50% plasticizer.

12. A pliable gingival isolation material comprising:
up to 10% water,
about 35 to 50% thickening agent, and
about 40 to 60% plasticizer.

13. A pliable gingival isolation material comprising:
about 15 to 30% water,
about 20 to 45% thickening agent, and
about 15 to 30% plasticizer.
